(19) United States
(12) Patent Application Publication
(10) Pub. No.: US 2006/0208407 A1
(43) Pub. Date: Sep. 21, 2006

(54) Clamping device

(76) Inventor: Guei-Ying Wang, Taichung City (TW)

Correspondence Address: CHARLES E. BAXLEY, ESQ., 90 JOHN STREET, THIRD FLOOR, NEW YORK, NY, 10038, US

(21) Appl. No.: 11/083,002

(22) Filed: Mar. 17, 2005

(51) Int. Cl. B25B 1/00

(52) U.S. Cl. 269/6

(57) ABSTRACT

A clamping device includes a first handle, a second handle, and a positioning unit. The positioning unit includes a sleeve pivotally mounted on the first handle, a rack pivotally mounted on the second handle and movably mounted in the sleeve, a control member pivotally mounted on the sleeve and having a first end extended into the sleeve, and a locking member mounted on the first end of the control member to move therewith and detachably engaged with the rack to limit movement of the rack. Thus, the locking member on the sleeve is normally engaged with the rack, so that the first handle and the second handle are positioned by the positioning unit rigidly and stably, thereby facilitating a user operating the claimping device.

### BACKGROUND OF THE INVENTION

1. Field of the Invention

The present invention relates to a clamping device, and more particularly to a clamping device for clamping a workpiece.

2. Description of the Related Art

A clamping device is used for clamping a workpiece, such as a wooden plate, metallic plate, plastic plate or the like. The clamping device usually comprises two clamping handles, and a positioning unit mounted between the two clamping handles. Thus, the positioning unit can lock and position the two clamping handles in place after the two clamping handles clamp the workpiece, thereby preventing the two clamping handles from being loosened due to hit of a foreign force.

A conventional clamping device in accordance with the prior art is disclosed in the Taiwanese Patent Publication No. 386480. However, when the shaft is slidable relative to the socket, the shaft easily vibrates due to a gap between the shaft and the socket, thereby causing inconvenience to a user when operating the clamping device. In addition, the shaft is easily worn out due to the vibration, thereby decreasing the lifetime of the shaft. Further, movement of the compression spring is affected by vibration of the shaft.

### SUMMARY OF THE INVENTION

The present invention is to mitigate and/or obviate the disadvantage of the conventional clamping device.

The primary objective of the present invention is to provide a clamping device having an efficiently positioning effect.

Another objective of the present invention is to provide a clamping device, wherein the locking member on the sleeve is normally engaged with the rack, so that the first handle and the second handle are positioned by the positioning unit rigidly and stably, thereby facilitating a user operating the clamping device.

A further objective of the present invention is to provide a clamping device, wherein the user only needs to press the pressing portion of the control member to unlock the positioning unit so as to adjust the angle between the first handle and the second handle, thereby facilitating the user adjusting the operation angle of the clamping device.

A further objective of the present invention is to provide a clamping device, wherein the rack is slidable in the slideway of the sleeve smoothly to adjust the angle between the first handle and the second handle exactly without producing vibration, thereby facilitating the user adjusting the operation angle of the clamping device.

In accordance with the present invention, there is provided a clamping device, comprising:

a first handle having a first end formed with a first jaw provided with a first clamp;

a second handle pivotally connected with the first handle and having a first end formed with a second jaw provided with a second clamp;

a positioning unit mounted between a second end of the first handle and a second end of the second handle to control a relative angle between the first handle and the second handle; wherein the positioning unit includes:

a sleeve pivotally mounted on the second end of the first handle;

a rack pivotally mounted on the second end of the second handle and movably mounted in the sleeve;

a control member pivotally mounted on the sleeve and having a first end extended into the sleeve;

a locking member mounted on the first end of the control member to move therewith and detachably engaged with the rack to limit movement of the rack.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a clamping device in accordance with the preferred embodiment of the present invention;

FIG. 2 is an exploded perspective view of the clamping device as shown in FIG. 1;

FIG. 3 is a plan view of the clamping device as shown in FIG. 1;

FIG. 4 is a schematic operational view of the clamping device as shown in FIG. 3; and

FIG. 5 is a schematic operational view of the clamping device as shown in FIG. 4.

### DETAILED DESCRIPTION OF THE INVENTION

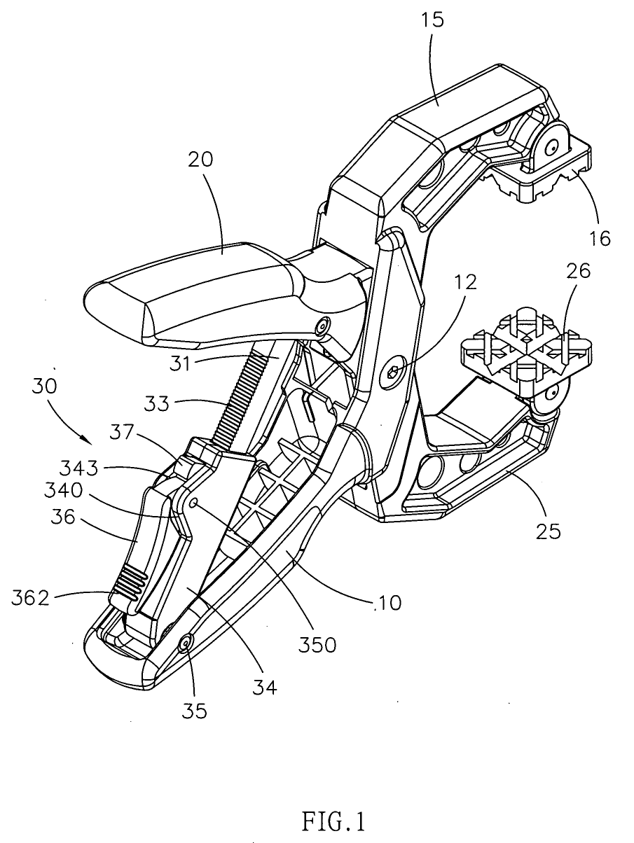

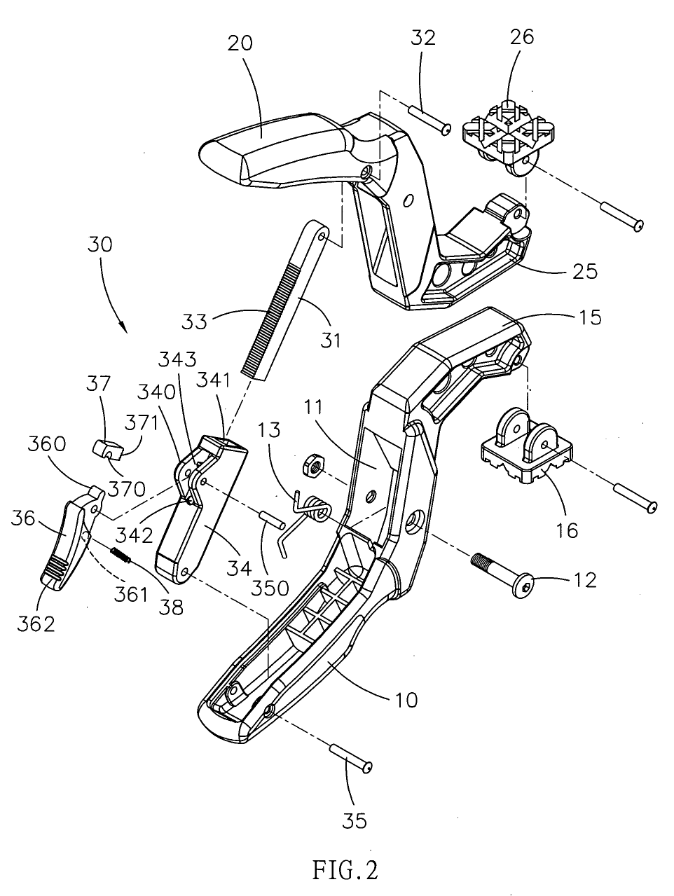

Referring to the drawings and initially to FIGS. 1-3, a clamping device in accordance with the preferred embodiment of the present invention comprises a first handle 10 having a first end formed with a first jaw 15 provided with a first clamp 16, a second handle 20 pivotally connected with the first handle 10 and having a first end formed with a second jaw 25 provided with a second clamp 26, and a positioning unit 30 mounted between a second end of the first handle 10 and a second end of the second handle 20 to control a relative angle between the first handle 10 and the second handle 20.

The first handle 10 has a mediate portion formed with a passage 11 to allow passage of the second handle 20. The second handle 20 is pivotally connected with the first handle 10 by a pivot shaft 12. A torsion spring 13 is mounted on the pivot shaft 12 and biased between the first handle 10 and the second handle 20 to open the first handle 10 and the second handle 20, so that the first jaw 15 of the first handle 10 and the second jaw 25 of the second handle 20 are moved outward relative to each other, and the second end of the first handle 10 and the second end of the second handle 20 are moved outward relative to each other.

The positioning unit 30 includes a sleeve 34 pivotally mounted on the second end of the first handle 10, a rack 31 pivotally mounted on the second end of the second handle 20 by a pivot shaft 32 and movably mounted in the sleeve 34, a control member 36 pivotally mounted on the sleeve 34 and having a first end extended into the sleeve 34, and a locking member 37 mounted on the first end of the control member 36 to move therewith and detachably engaged with the rack 31 to limit movement of the rack 31.

The sleeve 34 has an inside formed with a slideway 341 to receive the rack 31. The sleeve 34 has a first end having a side formed with a slot 343 connected to the slideway 341 to receive the first end of the control member 36 and the locking member 37 and a second end pivotally mounted on an inner face of the second end of the first handle 10 by a pivot shaft 35. The first end of the sleeve 34 is provided with two protruding pivot ears 340.

The rack 31 is slidably mounted in the slideway 341 of the sleeve 34 and has a side formed with a first engaged portion 33.

The first end of the control member 36 is pivotally between the pivot ears 340 of the sleeve 34 by a pivot shaft 350. The first end of the control member 36 has a periphery formed with an insert 360. The control member 36 has a second end formed with a serrated pressing portion 362.

The locking member 37 has a first end mounted on the insert 360 of the control member 36 to move therewith and a second end formed with a second engaged portion 371 detachably engaged with the first engaged portion 33 of the rack 31. The first end of the locking member 37 has a side formed with a mounting recess 370 to receive the insert 360 of the control member 36.

The positioning unit 30 further includes a compression spring 38 biased between the sleeve 34 and the control member 36 to push the first end of the control member 36 and the locking member 37 toward the rack 31 so that the locking member 37 is normally engaged with the rack 31. The control member 36 has a mediate portion formed with a mounting hole 361 for mounting a first end of the compression spring 38, and the sleeve 34 has a mediate portion formed with a mounting hole 342 for mounting a second end of the compression spring 38.

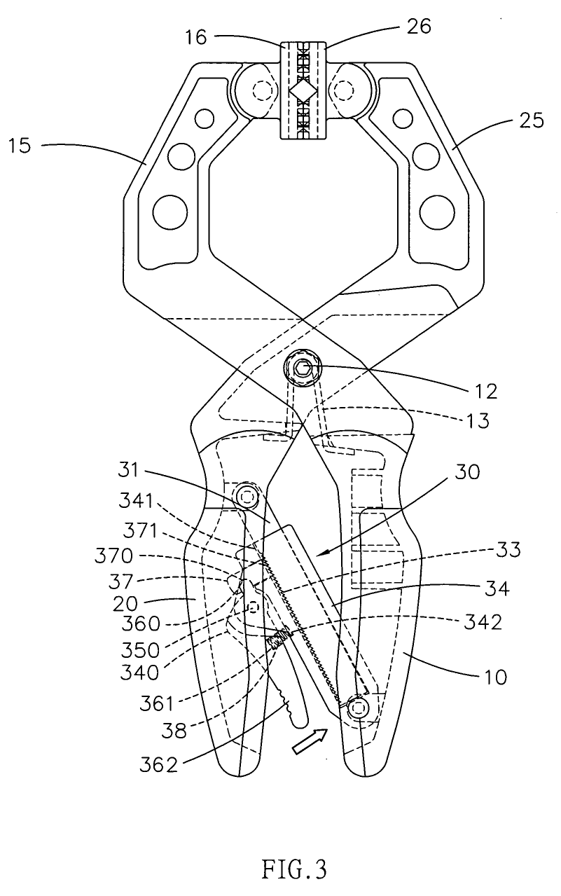

In operation, referring to FIGS. 1-5, the clamping device is initially disposed at a folded state, so that the first handle 10 and the second handle 20 are closed as shown in FIG. 3. At this time, the compression spring 38 pushes the first end of the control member 36 and the locking member 37 toward the rack 31 so that the locking member 37 is normally engaged with the rack 31. Thus, the sleeve 34 is locked by the rack 31 to fix the second end of the first handle 10 and the second end of the second handle 20, so that the first handle 10 and the second handle 20 are fixed by the positioning unit 30, thereby keeping the clamping device at a folded state.

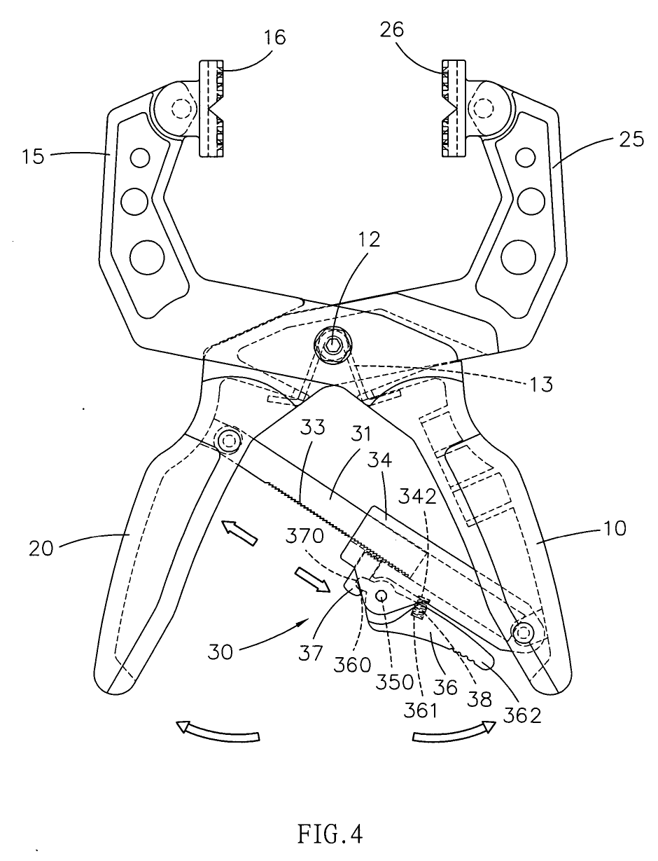

When the pressing portion 362 of the control member 36 is pressed toward the sleeve 34, the control member 36 is pivoted about the pivot shaft 350 to overcome the elastic force of the compression spring 38 to drive the first end of the control member 36 and the locking member 37 to move outward relative to the rack 31, thereby detaching the locking member 37 from the rack 31, and thereby detaching the rack 31 from the sleeve 34, so that the rack 31 is movable relative to the sleeve 34. At this time, the first handle 10 and the second handle 20 are moved outward relative to each other by the restoring force of the torsion spring 13, so that the rack 31 is movable outward relative to the sleeve 34 from the position as shown in FIG. 3 to the position as shown in FIG. 4, thereby opening the first handle 10 and the second handle 20 so as to open the clamping device.

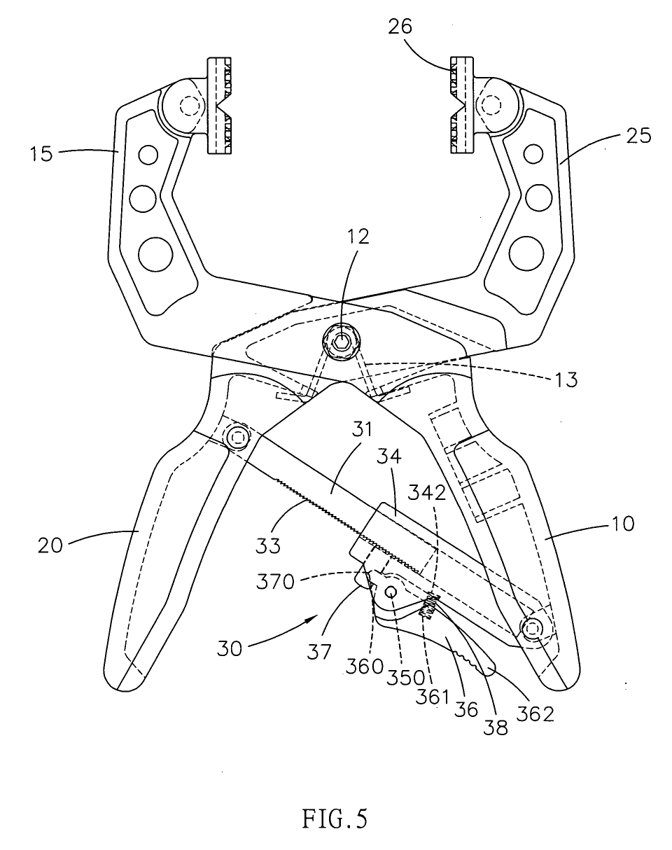

As shown in FIG. 5, when the angle between the first handle 10 and the second handle 20 reaches the determined value, the force applied on the pressing portion 362 of the control member 36 is removed, so that the control member 36 is pivoted back by the restoring force of the compression spring 38 to drive the first end of the control member 36 and the locking member 37 to move toward the rack 31 to engage the locking member 37 with the rack 31, thereby locking the sleeve 34 on the rack 31, and thereby fix the first handle 10 and the second handle 20 so as to fix the clamping device.

Accordingly, the locking member 37 on the sleeve 34 is normally engaged with the rack 31, so that the first handle 10 and the second handle 20 are positioned by the positioning unit 30 rigidly and stably, thereby facilitating a user operating the clamping device. In addition, the user only needs to press the pressing portion 362 of the control member 36 to unlock the positioning unit 30 so as to adjust the angle between the first handle 10 and the second handle 20, thereby facilitating the user adjusting the operation angle of the clamping device. Further, the rack 31 is slidable in the slideway 341 of the sleeve 34 smoothly to adjust the angle between the first handle 10 and the second handle 20 exactly without producing vibration, thereby facilitating the user adjusting the operation angle of the clamping device.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A clamping device, comprising:
a first handle having a first end formed with a first jaw provided with a first clamp;
a second handle pivotally connected with the first handle and having a first end formed with a second jaw provided with a second clamp;
a positioning unit mounted between a second end of the first handle and a second end of the second handle to control a relative angle between the first handle and the second handle; wherein the positioning unit includes:
a sleeve pivotally mounted on the second end of the first handle;
a rack pivotally mounted on the second end of the second handle and movably mounted in the sleeve;
a control member pivotally mounted on the sleeve and having a first end extended into the sleeve;
a locking member mounted on the first end of the control member to move therewith and detachably engaged with the rack to limit movement of the rack.

2. The clamping device in accordance with claim 1, wherein the rack is pivotally mounted on the second end of the second handle by a pivot shaft.

3. The clamping device in accordance with claim 1, wherein the sleeve has an inside formed with a slideway to receive the rack, and the rack is slidably mounted in the slideway of the sleeve.

4. The clamping device in accordance with claim 1, wherein the sleeve has a first end having a side formed with a slot connected to the slideway to receive the first end of the control member and the locking member.

5. The clamping device in accordance with claim 4, wherein the sleeve has a second end pivotally mounted on an inner face of the second end of the first handle by a pivot shaft.

6. The clamping device in accordance with claim 4, wherein the first end of the sleeve is provided with two protruding pivot ears, and the first end of the control member is pivotally between the pivot ears of the sleeve by a pivot shaft.

7. The clamping device in accordance with claim 1, wherein the control member has a second end formed with a serrated pressing portion.

8. The clamping device in accordance with claim 1, wherein the rack has a side formed with a first engaged portion, and the locking member has a first end mounted on the first end of the control member to move therewith and a second end formed with a second engaged portion detachably engaged with the first engaged portion of the rack.

9. The clamping device in accordance with claim 8, wherein the first end of the control member has a periphery formed with an insert, and the first end of the locking member is mounted on the insert of the control member to move therewith.

10. The clamping device in accordance with claim 9, wherein the first end of the locking member has a side formed with a mounting recess to receive the insert of the control member.

11. The clamping device in accordance with claim 1, wherein the positioning unit further includes a compression spring biased between the sleeve and the control member to push- the first end of the control member and the locking member toward the rack so that the locking member is normally engaged with the rack.

12. The clamping device in accordance with claim 11, wherein the control member has a mediate portion formed with a mounting hole for mounting a first end of the compression spring, and the sleeve has a mediate portion formed with a mounting hole for mounting a second end of the compression spring.

13. The clamping device in accordance with claim 1, wherein the first handle has a mediate portion formed with a passage to allow passage of the second handle.

14. The clamping device in accordance with claim 1, wherein the second handle is pivotally connected with the first handle by a pivot shaft.

15. The clamping device in accordance with claim 14, further comprising a torsion spring mounted on the pivot shaft and biased between the first handle and the second handle to open the first handle and the second handle, so that the first jaw of the first handle and the second jaw of the second handle are moved outward relative to each other, and the second end of the first handle and the second end of the second handle are moved outward relative to each other.
